(19) United States
(12) Patent Application Publication
(10) Pub. No.: US 2015/0191171 A1
(43) Pub. Date: Jul. 9, 2015

(54) SYSTEM FOR REDUCTION OF CONSUMPTION

(71) Applicant: Naser HASAN POUR ARBASTAN, Bruxelles (BE)

(72) Inventors: Naser Hasan Pour Arbastan, Bruxelles (BE); Ramin Tajarrodi, Bruxelles (BE)

(21) Appl. No.: 14/417,188

(22) PCT Filed: Jul. 22, 2013
(86) PCT No.: PCT/BE2013/000038

§ 371 Date: Jan. 26, 2015

(30) Foreign Application Priority Data
Jul. 24, 2012 (FR) 12/02092
Feb. 27, 2013 (FR) 13/00444

(51) Int. Cl. B60W 30/18; B60W 10/18; B60W 50/14; B60W 10/06; B60W 10/08; B60W 10/10; B60W 10/02

(52) U.S. Cl. CPC B60W 30/18072; B60W 10/10; B60W 30/18127; B60W 10/18; B60W 10/02; B60W 10/06; B60W 10/08; B60W 50/14; B60W 2030/1809

(57) ABSTRACT

System for Reduction of Consumption (SRC) of energy by motor vehicles by automatic and safety use of their kinetic energy, consisting of a management computer which triggers off, in order, the following operations if the accelerator position sensor indicates a constant, decreasing or the minimum level:
1° releasing the traction wheels, by an electromechanical device, in order to use the kinetic energy of vehicle;
2° reducing the energy consumption of engine by element of its management computer; and
3° turning on a warning light on the dashboard to indicate the SRC activation. The SRC management computer reverses the previous operations in the opposite order, during at least 3 seconds, if required by the safety and driving conditions.

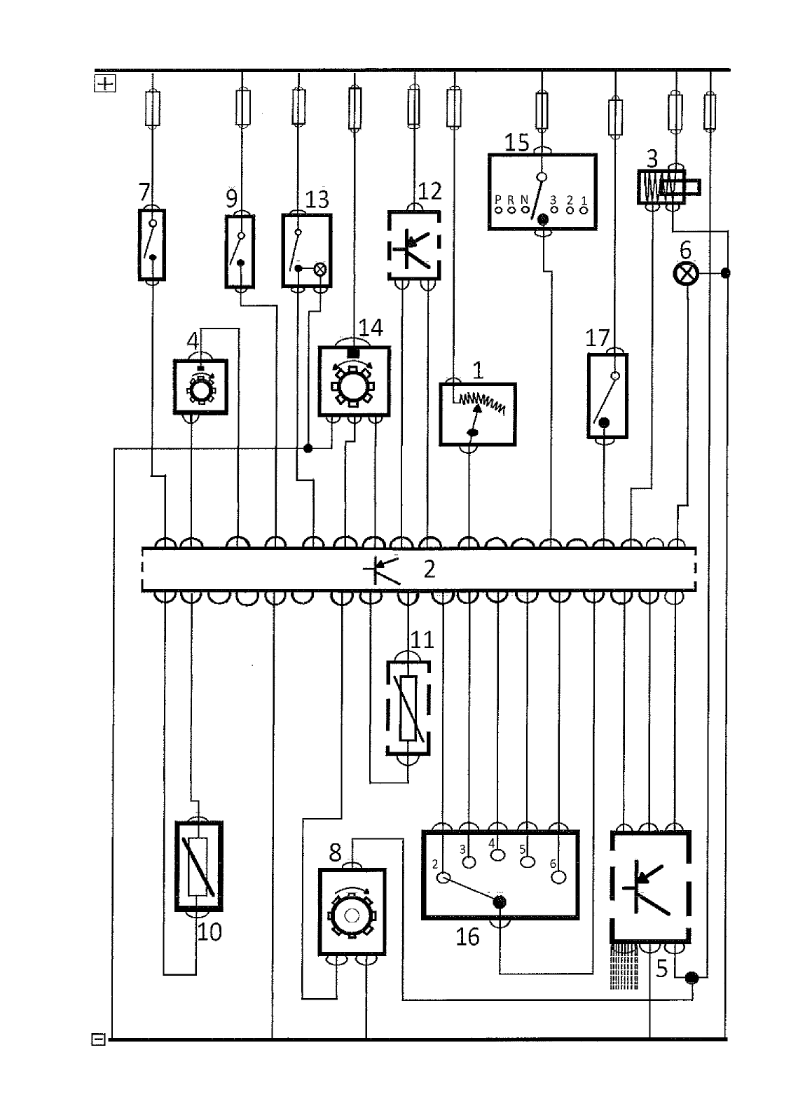

### TECHNICAL FIELD

The present invention concerns a System for Reduction of Consumption (SRC) of energy by motor vehicles by means of automatic and safety use of their kinetic energy.

### PRIOR ART

Currently the kinetic energy of motor vehicles is not used optimally because of the engine brake. But this is deemed necessary, particularly for safety reasons. So the problem is how to use the most the kinetic energy of vehicle safely.

### DESCRIPTION OF THE INVENTION

The system according to the invention provides a solution to this problem. It comprises, according to a first feature, an accelerator position sensor which allows distinguishing two cases:

a) In the situations where the accelerator position sensor indicates a constant, decreasing or the minimum level, the vehicle speed is either sufficient or too high. In these situations, the SRC management computer triggers off the following operations:
1° releasing the traction wheels, by an electromechanical device, to use the kinetic energy of vehicle;
2° reducing the energy consumption of the engine by means of its management computer;
3° turning on a warning light on the dashboard to indicate the activation of SRC.

b) In the situation where the accelerator position sensor indicates an increasing or the maximum level, the vehicle speed is either insufficient or to maintain. In this situation, as well as in those where the driving or safety conditions require, the SRC management computer reverses in the opposite order, the operations described in (a) for at least 3 seconds.

### BRIEF DESCRIPTION OF THE DRAWING

The attached electronic map shows the elements of the invention and their connections.

### WAYS OF IMPLEMENTING THE INVENTION

Referring to the map, the system consists of a management computer (2) which triggers off, in order, the following operations if the accelerator position sensor (1) indicates a constant, decreasing or the minimum level:
1° releasing the traction wheels, by an electromechanical device (3), to use the kinetic energy of vehicle:
   In the case of vehicles with automatic gearbox, by changing the gear from D to N without changing the position of gearshift;
   In the case of vehicles with a manual gearbox, by declutching;
   In the case of electric vehicles, by interrupting the battery charging process;
2° reducing the energy consumption of engine by means of its management computer (5):
   In the case of vehicles with an internal combustion engine, by reducing the engine speed to idle;
   In the case of vehicles with an electric engine, by interrupting the electrical input of engine;
3° turning on a warning light on the dashboard (6) to indicate the activation of SRC.

The SRC management computer (2) reverses the previous operations in the opposite order, during at least 3 seconds, if it receives one of the following information:
The accelerator position sensor (1) indicates an increasing or maximum level;
The speed sensor (8) indicates a speed below 25 km/h or above 120 km/h;
The speed sensor (8) indicates a falling speed of more than one kilometer per second while the accelerator position sensor (1) indicates a constant level. In this case, the SRC management computer (2) can no longer trigger off the operations mentioned in the previous paragraph as long as the accelerator position sensor (1) does not indicate a decreasing level.
The hand brake switch (7) or brake switch (9) indicates a braking;
A security system such as ESP, TCS, etc. (12) is activated;
The SRC is turned off by its manual control on the dashboard (13) (for example, in extreme conditions or for aggressive driving);
In the case of vehicles with automatic gearbox, the gearshift is in a position other than D;
In the case of vehicles with manual gearbox:
   Or the gear switch (16) indicates the neutral, first or reverse gear;
   Or the speed sensor (8) indicates a higher speed than the maximum level allowed for the active gear, which level is set according to the characteristics of vehicle;
   Or the engine speed sensor (4) indicates a higher level than the maximum speed allowed for the active gear, which level is set according to the characteristics of vehicle;
   Or the clutch switch (17) indicates a complete declutching.
The steering position sensor (14) indicates a rotation higher than a measure inversely proportional to the vehicle speed. This measure is calculated by the SRC management computer (2) according to the characteristics of vehicle;
The engine temperature sensor (10) indicates a temperature below 30 C.°;
The outdoor temperature sensor (11) indicates a temperature below 3 C.°;

The reversal of operations described in the preceding paragraph by the SRC management computer (2), in the opposite order, involves:
1° turning off the SRC warning light on the dashboard (6);
2° recovering the energy supply of engine by means of its management computer (5);
3° re-engaging the drive wheels by the electromechanical device (3):
   In the case of vehicles with an automatic gearbox, changing the gear from N to D, without changing the position of gearshift;
   In the case of vehicles with a manual gearbox, causing a clutching;
   In the case of electric vehicles, allowing the recharge of batteries.

### INDUSTRIAL APPLICABILITY

The system according to the invention is intended to reduce the energy consumption of motor vehicles.

### THE DRAWING LEGEND

1: Accelerator position sensor
2: SRC management computer
3: Electromechanical device
4: Engine speed sensor
5; Engine management computer
6: Warning light on the dashboard
7: Handbrake switch
8: Speed Sensor
9: Brake switch
10: Engine temperature sensor
11: Outside temperature sensor
12: Safety system (ESP, ASR, etc.)
13: SRC manual control on dashboard
14: Steering position sensor
15: Gearshift switch
16: Gear switch
17: Clutch switch

1-10. (canceled)

11. A system for reducing energy consumption of a motor vehicle, the system comprising a management computer connected to the engine management computer, and an accelerator position sensor, a speed sensor, a handbrake switch, a brake switch, an electromechanical device for releasing the traction wheels, connected to the management computer, wherein the management computer is designed to trigger off, in sequence, the following operations: if the accelerator position sensor indicates a constant, decreasing or the minimum level, releasing the traction wheels by control of the electromechanical device, reducing the energy consumption of the engine by the engine management computer.

12. The system of claim 11 wherein the system is designed for vehicles comprising an automatic gearbox, and the electromechanical device for releasing the traction wheels changes the gear from D to N without changing the position of gearshift.

13. The system of claim 11 wherein the system is designed for vehicles comprising a manual gearbox, and the electromechanical device for releasing the traction wheels declutches.

14. The system of claim 11 wherein the system is designed for vehicles comprising an electrical engine, and the electromechanical device for releasing the traction wheels interrupts the battery charging process.

15. The system of claim 11 wherein it is designed for an internal combustion engine and the engine management computer is controlled to reduce the engine speed to idle.

16. The system of claim 11 wherein it is designed for an electric engine and the engine management computer is controlled to reduce energy consumption by interrupting the electrical input of the engine.

17. The system of claim 11 wherein the management computer is designed to turn on a warning light, preferably on the dashboard, after having reduced the energy consumption by the engine.

18. The system of claim 11 wherein the management computer is designed to reverse the operations in the opposite order, during at least 3 seconds, if the accelerator position sensor indicates an increasing or maximum level.

19. The system according to claim 11, wherein the management computer is designed to reverse the operations in the opposite order, during at least 3 seconds, if it receives one of the following information:
the speed sensor indicates a speed below 25 km/h or above 120 km/h;
the speed sensor indicates a falling speed of more than one kilometer per second while the accelerator position sensor (1) indicates a constant level, in which case the management computer can no longer trigger off the operations until the accelerator position sensor indicates a decreasing level.

20. The system according to claim 11, wherein the management computer is designed to reverse the operations listed in the opposite order, during at least 3 seconds, if the hand brake switch or the brake switch indicates a braking.

21. The system according to claim 11, wherein the management computer is designed to reverse the operations listed in the opposite order, during at least 3 seconds, if it is designed for a vehicle comprising an automatic gearbox and the gearshift is in a position other than D.

22. The system according to claim 11, wherein the system potentially further comprises an engine speed sensor connected to the management computer, and wherein the management computer is designed to reverse the operations in the opposite order, during at least 3 seconds, if it is designed for a vehicle comprising a manual gearbox and at least one of the following situations occurs:
the gear switch shows the neutral, first or reverse gear,
the speed sensor indicates a higher speed than the maximum level allowed for the active gear, which level is set according to the characteristics of vehicle,
the engine speed sensor indicates a higher speed than the maximum level allowed for the active gear, which level is set according to the characteristics of vehicle,
the clutch switch indicates a complete declutching

23. The system according to claim 11, wherein the management computer is designed to reverse the operations in the opposite order, during at least 3 seconds, if the steering position sensor indicates a rotation higher than a value inversely proportional to the vehicle speed, said value being calculated by the management computer according to the characteristics of vehicle.

24. The system according to claim 11, wherein the management computer is designed to reverse the operations in the opposite order, during at least 3 seconds, if the system is designed for a vehicle equipped with a safety system, such as ESP or ASR etc, and said safety system is activated.

25. The system according to claim 11, wherein the management computer is designed to reverse the operations in the opposite order, during at least 3 seconds, if
an engine temperature sensor is connected to the management computer and the engine temperature sensor indicates a temperature below 30 C.°,
an outdoor temperature sensor is connected to the management computer and the outdoor temperature sensor indicates a temperature below 3 C.°.

26. The system according to claim 11 further comprising a manual control wherein the management computer is designed to reverse the operations in the opposite order, during at least 3 seconds, if the manual control turns off the system.

27. A motor vehicle equipped with a system for reducing energy consumption of a motor vehicle, the system comprising a management computer connected to the engine management computer, and an accelerator position sensor, a speed sensor, a handbrake switch, a brake switch, an electromechanical device for releasing the traction wheels, connected to the management computer, wherein the management computer is designed to trigger off, in sequence, the following operations: if the accelerator position sensor indicates a constant, decreasing or the minimum level, releasing the traction wheels by control of the electromechanical device, reducing the energy consumption of the engine by control of the engine management computer.

28. A process for reducing energy consumption of a motor vehicle, the process comprising providing a system for reducing energy consumption of a motor vehicle, the system comprising a management computer connected to the engine management computer, and an accelerator position sensor, a speed sensor, a handbrake switch, a brake switch, an electromechanical device for releasing the traction wheels, connected to the management computer, the process further comprising, in sequence, if the accelerator position sensor indicates a constant, decreasing or the minimum level, the releasing of the traction wheels and the reduction of the energy consumption of the engine by the engine management computer.

29. The process of claim 28 further comprising reversing the operations in the opposite order, during at least 3 seconds, if the accelerator position sensor indicates an increasing or maximum level.

30. The process of claim 28 further comprising reversing the operations in the opposite order, during at least 3 seconds, if:
the speed sensor indicates a speed below 25 km/h or above 120 km/h;
the speed sensor indicates a falling speed of more than one kilometer per second while the accelerator position sensor (1) indicates a constant level, in which case the management computer can no longer trigger off the operations until the accelerator position sensor indicates a decreasing level.
